(19) United States
(12) Patent Application Publication
(10) Pub. No.: US 2025/0256138 A1
(43) Pub. Date: Aug. 14, 2025

(54) FIRE-RESISTING GASKET

(71) Applicant: ASSA ABLOY Accessories and Door Controls Group, Inc., New Haven, CT (US)

(72) Inventors: Terry Agee, Somerset, PA (US); Kristy Jones, Morehead, KY (US)

(73) Assignee: ASSA ABLOY Accessories and Door Controls Group, Inc., New Haven, CT (US)

(21) Appl. No.: 19/043,753

(22) Filed: Feb. 3, 2025

Related U.S. Application Data
(60) Provisional application No. 63/551,646, filed on Feb. 9, 2024.

(51) Int. Cl. A62C 2/06

(52) U.S. Cl. CPC A62C 2/065

(57) ABSTRACT

A fire-resisting gasket is disclosed, as well as methods of manufacture and methods of installation of the fire-resisting gasket. In some embodiments, the fire-resisting gasket may be flexible such that it may be rolled into a spool. In some embodiments, the fire-resisting gasket may be configured to expand when exposed to temperatures above a threshold temperature. In some embodiments, a thickness of the fire resisting gasket is approximately 1/16 inch. In some embodiments, the fire-resisting gasket may be configured to be applied in gaps between a door and the door's door jambs.

### CROSS-REFERENCE TO RELATED APPLICATIONS

This application claims the benefit under 35 U.S.C. 119(e) of U.S. Application Ser. No. 63/551,646, filed Feb. 9, 2024, titled “FIRE-RESISTING GASKET”, the entire contents of which is incorporated by reference herein.

### FIELD

The field generally relates to fire-resisting gaskets configured to restrict fire from circumventing doors, windows, and other openings.

### BACKGROUND

Modern building design often incorporates various fire protection systems to limit the outbreak and spread of fires in buildings. Often, local building codes require such systems to be in place for a building to be considered safe for use and/or occupancy. Such fire protection systems may be active systems, such as sprinklers or passive systems. Passive fire protections systems are generally configured to limit the spread of a fire from one room to another by using fire resistant materials to form room boundaries. Limiting the spread of fire may be crucial to allow for safe evacuation of the building and limiting the amount of damage done by the fire prior to extinguishing.

Passive fire protections systems seal off compromised rooms from other rooms in the building to prevent fire from spreading between rooms. Establishing such a seal may be difficult at the entry/exit points of the rooms. Even if the doors are constructed of fire-resistant materials, fire and smoke may spread through gaps between the sides of the doors and their respective door jambs. It is therefore necessary to seal these gaps around doors in order to have an effective passive fire protection system.

### SUMMARY

In some embodiments, a fire-resisting gasket comprises an outer casing, at least one intumescent strip at least partially surrounded by the outer casing, and an adhesive backing material attached to the outer casing to hold the intumescent material to the outer casing and configured to secure the fire-resisting gasket to a support surface. The at least one intumescent strip is configured to expand when exposed to a temperature above a threshold temperature. The fire-resisting gasket is flexible and rolled into a spool.

In some embodiments, a method of forming a spool of fire-resisting gasket is disclosed, where the fire-resisting gasket comprises an outer casing, at least one intumescent strip at least partially surrounded by the outer casing, and an adhesive backing material attached to the outer casing. The method comprises extruding the outer casing at a pre-determined temperature, cooling the outer casing such that the outer casing remains flexible, inlaying the at least one intumescent strip into the outer casing, attaching the adhesive backing to the outer casing, cutting the fire-resisting gasket to a pre-determined length, and rolling the fire-resisting gasket into a spool.

In some embodiments, a method of installing a section of fire-resisting gasket onto a support surface from a spool of fire-resisting gasket where the fire-resisting gasket comprises an outer casing, at least one intumescent strip at least partially surrounded by the outer casing, and an adhesive backing material attached to the outer casing. The method comprises measuring a length of the support surface, unrolling at least a portion of the fire-resisting gasket from the spool of the fire resisting gasket, cutting off a section of the fire-resisting gasket from the unrolled fire-resisting gasket, the section having a cut length corresponding to the length of the support surface, and attaching the adhesive backing to the support surface along the length of the support surface.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A shows a perspective view of a portion of an excessive gap gasket according to an embodiment.

FIG. 1B shows a cross-sectional view of the excessive gap gasket according to the embodiment of FIG. 1A.

FIG. 2A shows a schematic representation of the gasket of FIG. 1A in the unexpanded state attached between a door jamb and a door.

FIG. 2B shows a schematic representation of the gasket of FIG. 1A in the expanded state attached between a door jamb and a door.

FIG. 3A shows a perspective view of a portion of an excessive gap gasket according to an embodiment.

FIG. 3B shows a cross-sectional view of the excessive gap gasket according to the embodiment of FIG. 3A.

FIG. 4A shows a schematic representation of the gasket of FIG. 3A in the unexpanded state attached between a door jamb and a door.

FIG. 4B shows a schematic representation of the gasket of FIG. 3A in the expanded state attached between a door jamb and a door.

FIG. 5 shows a gasket rolled into a spool after manufacturing.

FIG. 6 shows a flowchart detailing a method of manufacture for forming gasket into a spool.

FIG. 7 shows a flowchart detailing a method of attaching a gasket to a door jamb.

FIG. 8 shows gaskets attached to door jambs using the method described in FIG. 7.

### DETAILED DESCRIPTION

As discussed above, one challenge with creating effective passive fire protection systems involves slowing the spread of fire through gaps between doors and their respective door jambs. Generally, gaps over ⅛″ are considered “excessive gaps”, and are too large to effectively slow the spread of fire. Many local fire codes require remedial measures to be taken with fire doors with excessive gaps.

One method of reducing excessive gaps would be to replace or remount doors to reduce the gap. However, doing so may be prohibitively expensive for many building owners, and may not be effective in buildings which undergo substantial expansion and contraction.

Another remedy is to install “excessive gap” gaskets between sides of the doors and their door jambs. These gaskets include at least one intumescent strip below an outer cover. If these gaskets are exposed to sufficient heat, they are configured to expand to seal the gaps between the doors and the door jambs. A gasket effectively or properly seals such a gap by preventing the spread of fire through that gap for a prerequisite amount of time, such as 20 minutes, 45 minutes, 60 minutes, or 90 minutes. This allows doors to be used normally, while allowing for complaint and effective level of fire resistance. Such gaskets may be retrofitted onto existing noncompliant doors, which provides a cost and time efficient method of bringing existing non-compliant fire doors into compliance with local fire codes.

However, conventional excessive gap gaskets still have several drawbacks. First, the outer cover of these conventional gaskets is rigid. This increases the footprint that the gasket occupies during shipping, storage, and when stocked in stores, all of which may increase the cost of the gasket. For instance, if an 8-foot section is needed for a door, the conventional gaskets must be shipped in at least an 8-foot-long package. Additionally, a rigid outer cover requires either ordering a custom gasket of the required length, which may increase cost, or cutting predefined lengths to size to fit specific doors, which may generate unnecessary waste. A rigid outer cover may also be difficult to cut or modify to fit a specific door.

Additionally, conventional excessive gap gaskets only achieve an effective seal when used with additional components such as metal door stop extenders. These doors stop extenders may become bent during shipping, which may lead to additional time delays and costs.

Additionally, conventional excessive gap gaskets may not be usable with fire doors with uneven gaps. In order to effectively seal excessive gaps, conventional excessive gap gaskets can be greater than 1/16-inch-thick pre-expansion. However, the size of the gap may vary along a side of the door, or the gap on one side of the door may be different from the gap on another side of the door. For instance, the gap along one side may be ¼ inch at the top of the door, but 3/32 inch at the bottom of the door. Conventional excessive gap gaskets would be unusable in this scenario because the gap at the bottom is too small to accommodate the greater than 1/16-inch-thick gasket. Also, even if the gap were large enough to accommodate the conventional gasket, the conventional gasket may apply excessive force to the bottom of the door and frame when expanded, potentially damaging the door and/or the frame, or bind against the side of the door and interfere with proper operation of the door.

The inventors have therefore recognized an advantage to an intumescent gasket configured to effectively seal excessive gaps without the use of additional components. The inventors have also recognized an advantage to an excessive gap gasket which is substantially thinner than conventional excessive gap gaskets, in order to allow for use on fire doors with uneven gaps. Additionally, the inventors have recognized an advantage to a flexible excessive gap gasket, which may allow the gasket to be rolled up for shipping, storage, and stocking on store shelves.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

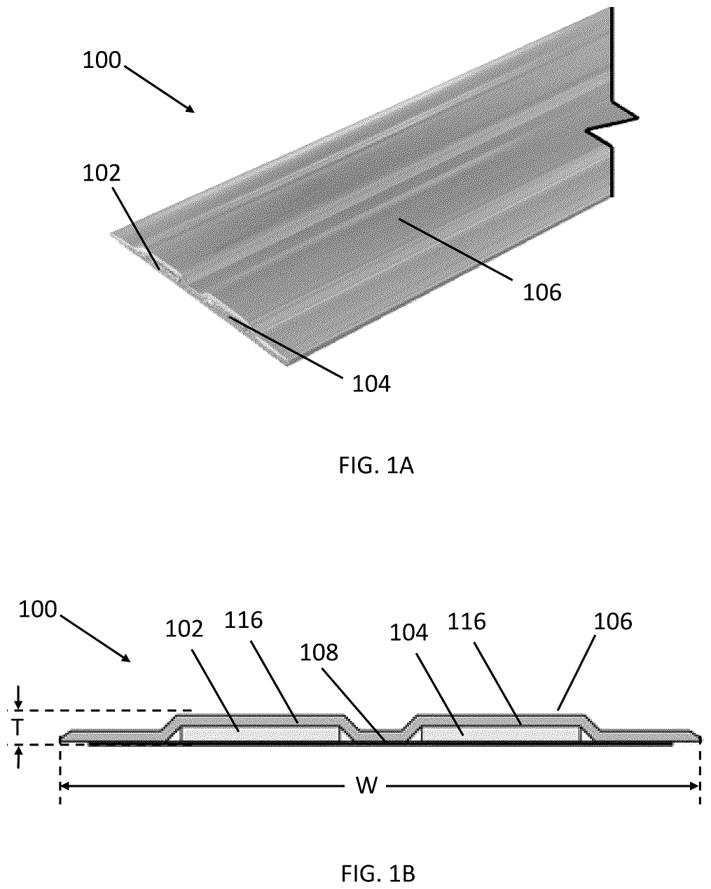

FIG. 1A shows a perspective view of a portion of an excessive gap gasket according to an embodiment, and FIG. 1B shows a cross-sectional view of the excessive gap gasket according to the embodiment of FIG. 1A.

In some embodiments, gasket 100 may include a first intumescent strip 102 a second intumescent strip 104. The first and second intumescent strips 102 and 104 may be configured to expand when exposed to an ambient temperature greater than a threshold temperature. In some embodiments, the threshold temperature is between 300° F. and 500° F. In some embodiments, the threshold temperature is approximately 390° F. While gasket 100 is shown with 2 intumescent strips, it is contemplated that any number of intumescent strips may be used in gasket 100.

In some embodiments, gasket 100 in the unexpanded state may have a gasket thickness T of less than ⅛ inch. In some embodiments, gasket thickness T is approximately 1/16 inch. In some embodiments, a thickness of the intumescent strips 102 and 104 is approximately 1 mm. It is contemplated that gasket 100 may have any suitable width W. In some embodiments, width W is between 1-2 inches. In some embodiments, width W is approximately 1 9/16 inch.

The gasket 100 may also include an outer cover 106 configured to at least partially encapsulate the intumescent strips 102 and 104. In some embodiments, intumescent strips 102 and 104 are disposed in divots 116 in outer cover 106. Outer cover 106 may protect the intumescent strips 102 and 104 from damage. In some embodiments, outer cover 106 may be colored as desired to match the color of the support surface it is attached to. Outer cover 106 may be configured to soften at a threshold temperature that is less than or equal to the intumescent strip expansion threshold temperature. When softened, outer cover 106 may stretch as the intumescent strips expand.

In some embodiments, outer cover 106 may be rigid at ambient room temperatures. In some embodiments, outer cover 106 may be flexible at ambient room temperatures. Such a flexible configuration may allow for the gasket 100 to be rolled after manufacture. This greatly reduces the footprint of the gasket, which may be advantageous for shipping and storage purposes. More details on the flexible outer cover will be discussed below.

The gasket 100 may also include an adhesive backing 108 opposite the outer cover 106. Such an adhesive backing may allow for the gasket 100 to be applied to a suitable support surface, such as a door jamb. In some embodiments, the adhesive backing is a double-sided tape, such that it may adhere to the outer cover 106 and intumescent strips 102 and 104, as well as to door jamb surface 208 (as detailed below).

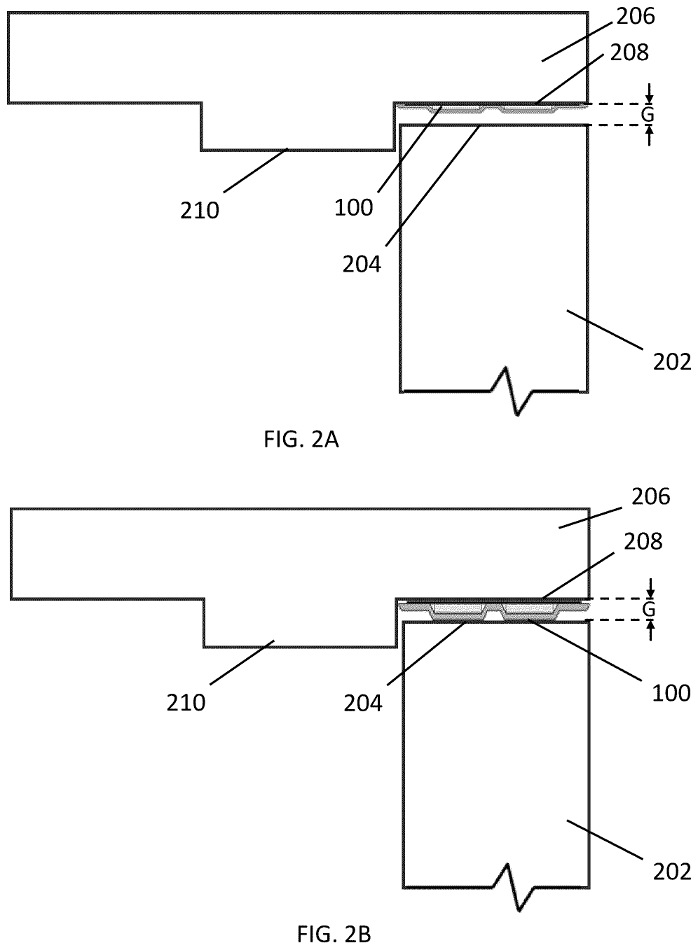

FIGS. 2A and 2B show a schematic representation of the gasket 100 being used to seal gaps between a door jamb 206 and a door 202 in the unexpanded and expanded states respectively.

Door 202 is configured to be inset inside of door jamb 206. In the closed configuration, door side 204 is approximately parallel with door jamb surface 208, and separated by gap G. When door 202 is in a closed configuration, stopper plate 210 may prevent the door 202 from over-rotating and ensure proper alignment of door side 204 with door jamb surface 208. It is contemplated that door side 204 may be any side of the door, such as a hinge side, a latch side or a header side. It is contemplated that door jamb 206 may be any door jamb, such as a hinge-side jamb, a latch-side jamb, or a header jamb.

In some embodiments, the gasket 100 may attached to door jamb 206 in order to seal gap G around a door and slow the spread of fire around the door. To attach the gasket 100, adhesive backing 108 may applied to a door jamb surface 208, such that outer covering 106 extends towards door side 204. In some embodiments, support surface 208 may be cleaned, sanded, or otherwise prepared prior to attachment of adhesive backing 108, in order to achieve proper adhesion.

In some embodiments, the gasket 100 may be attached to door jamb surface 208 when gap G is at least 1/16 inch along the door jamb 206. In some embodiments, the gasket 100 may be attached to a door jamb surface 208 when gap G is at least 3/32 inch along the door jamb 206.

If the threshold ambient temperature is reached, intumescent strips expand and cause the gasket 100 to expand across gap G and contact door side 204. When expanded, gasket 100 may seal the door 202 in place and prevent the spread of fire around the door through gap G.

In some embodiments, gasket 100 may be configured to prevent the spread of fire for 45 minutes. In other embodiments, gasket 100 may be configured to prevent the spread of fire for other amounts of times, such as 20, 60, or 90 minutes.

In some embodiments, gasket 100 may be configured to effectively seal a gap G of up to ¼ inch. In some embodiments, gasket 100 may be configured to effectively seal a gap G of between 1/16 inch and ¼ inch. In some embodiments, gasket 100 may effectively seal gap G without the use of any additional components, such as door stop extenders.

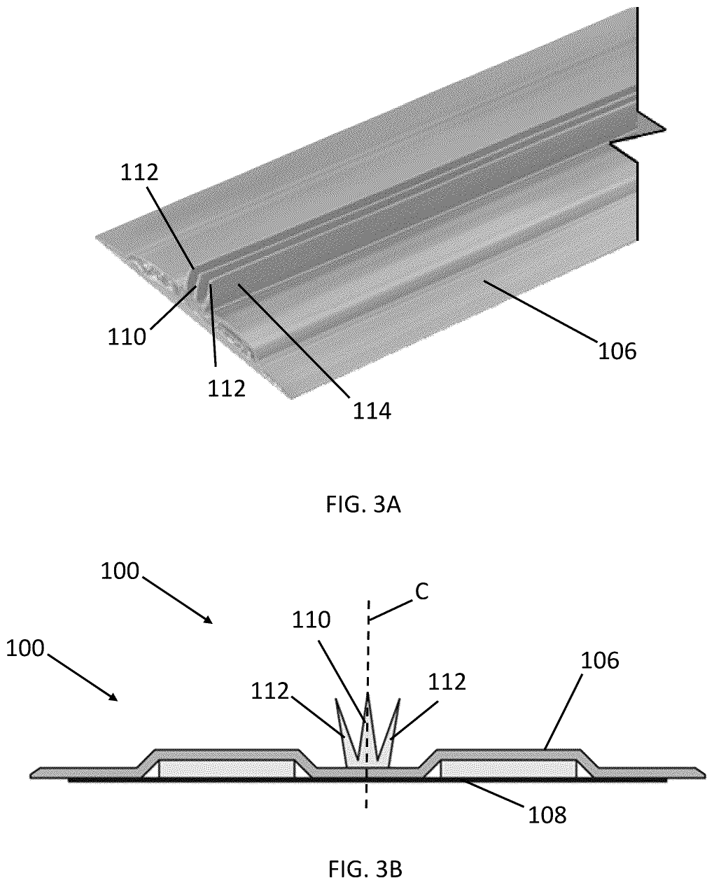

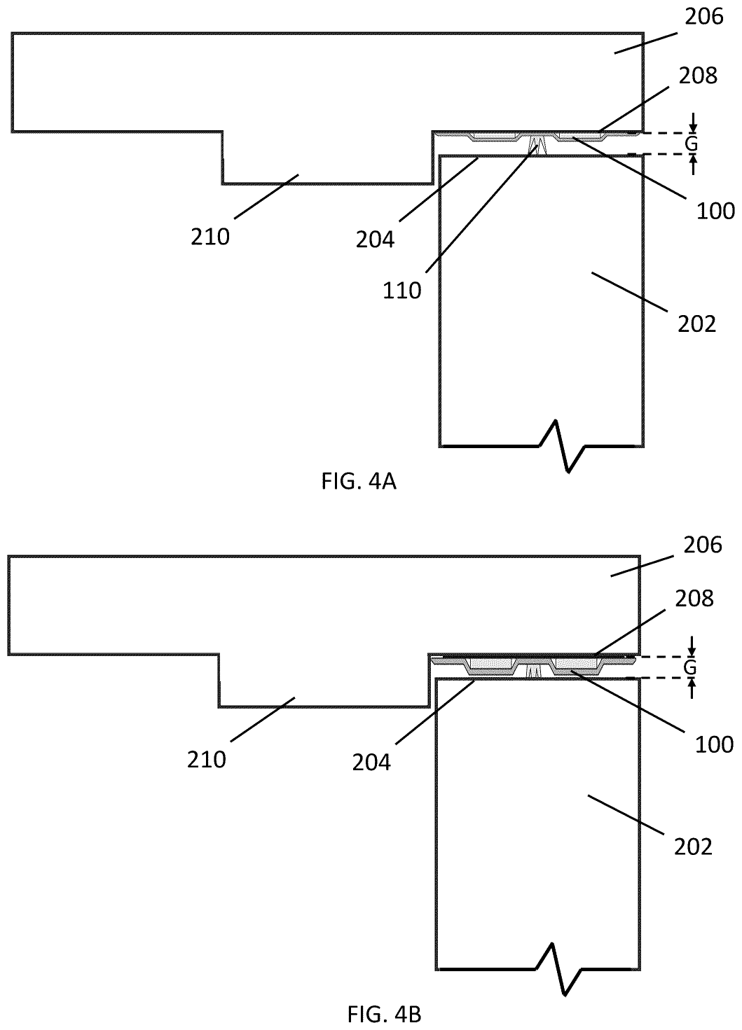

FIG. 3A shows a perspective view of a portion of an intumescent gasket according to an embodiment, and FIG. 3B shows a cross-sectional view of the intumescent gasket according to the embodiment of FIG. 3A. FIGS. 4A and 4B show views of the gasket according to the embodiment of FIG. 3A attached to a door jamb.

In some embodiments, it may be desirable for gasket 100 to at least partially seal gap G even when the gasket 100 is in the unexpanded state. This may be desirable to prevent smoke from flowing through gaps in the door frame before the ambient temperature is sufficient to activate the intumescent strips.

Gasket 100 may therefore include a fin 110 extending from outer cover 106. As can be seen in FIG. 4A, when gasket 100 is attached to door jamb 208, fin 110 extends across gap G and contacts door side 204, even when gasket 100 is in the unexpanded state. Fin 110 may therefore limit the flow of smoke around gap G.

In some embodiments, it may be desirable for fin 110 to be formed of an elastomeric material. This may allow fin 110 to bend so that fin 100 does not interfere with the opening and closing of the door 202. Additionally, if fin 110 is bent when in contact with door side 204, fin 100 may have an increased surface area in contact with door 204, which may increase the effectiveness of the seal. It is contemplated that fin 110 may extend from outer cover 106 at any point on outer cover 106. For instance, as depicted in FIG. 3A, fin 110 may be located along a center line C outer cover 106.

In some embodiments, it may be desirable to increase the number of fins in order to increase the effectiveness of the sealing effect of gasket 100 in the unexpanded state. Gasket 100 may therefore include auxiliary fins 112 extending from outer cover 106 and configured to extend across gap G and contacts door side 204. In some embodiments, auxiliary fins may extend approximately parallel with fin 110. In some embodiments, auxiliary fins 112 may extend at an angle relative to fin 110. In some embodiments, this angle is between 5° and 45°. Without wishing to be bound by theory, it is contemplated that configuring the auxiliary fins to extend at angles relative to fin 110 may allow for more effective sealing and less interference with door operation. In some embodiments, as best seen in FIG. 3A, outer sides of auxiliary fins 112 may include curved surface 114. Without wishing to be bound by theory, it is contemplated that curved surface 114 may allow for more effective sealing and reduce interference with operation of the door by the gasket.

In some embodiments fin 110 and auxiliary fins 112 may be integrally formed with outer cover 106. In some embodiments, fin 110 and auxiliary fins 112 may be permanently or removably attached from outer cover 106 before or after installation of gasket 100.

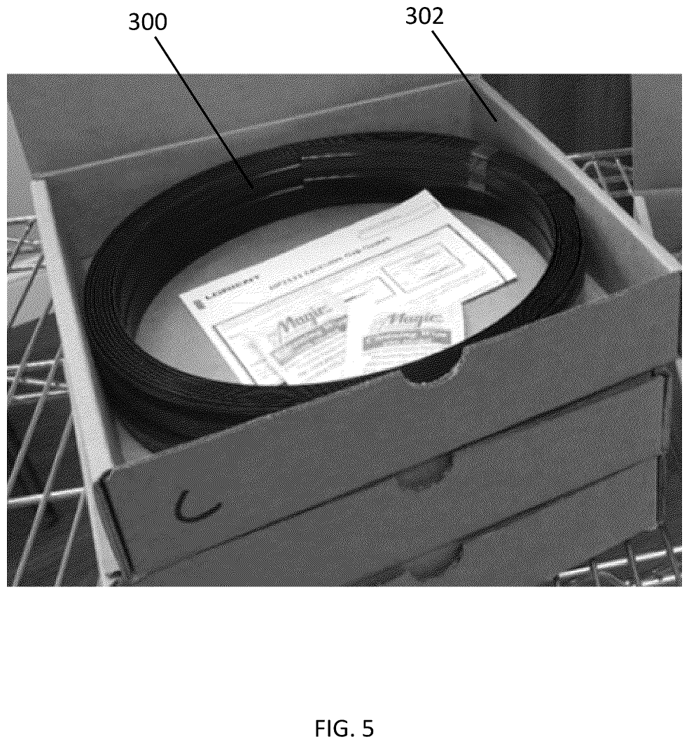

FIG. 5 shows a gasket 100 rolled into a spool 300 after manufacturing. As mentioned above, it may be desirable for gasket 100 to be rolled up for more efficient shipping, storage, stocking, and installation. However, if the outer cover is too rigid, it may kink or facture instead of bending while being rolled. Additionally, a rigid outer cover may experience “shape memory”, where, once bent, the outer cover tends to retain the bent shape of the roll when unspooled. This may make installation more difficult and may result in the gasket detaching from support structure after installation. It therefore may be desirable to manufacture a flexible gasket that experiences little or no shape memory.

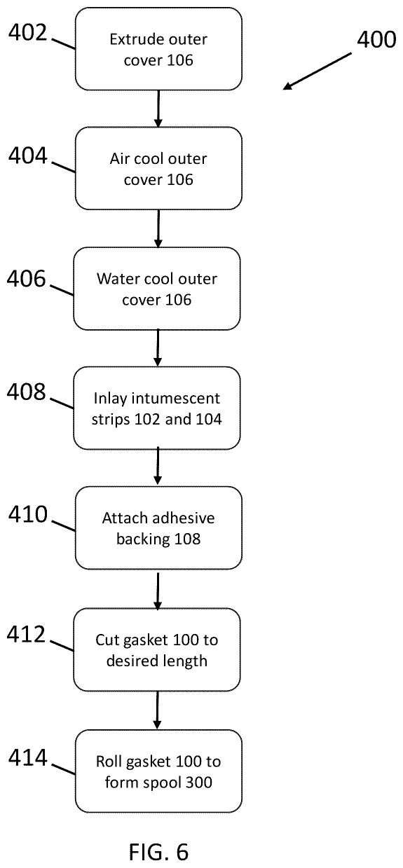

FIG. 6 shows a flowchart detailing a method of manufacture 400 for forming gasket 100 to into spool 300. At 402, the outer cover 106 is first extruded using any conventional means. In some embodiments, a flexible outer cover 106 is extruded at a lower temperature than a rigid outer cover 106 would be extruded at to achieve more flexible bending properties. This lower temperature may be any suitable lower temperature. In some embodiments, this lower temperature is between 300° F. and 350° F. In some embodiments, this temperature is approximately 325° F. At 404, the outer cover 106 is allowed to air cool after extrusion. In some embodiments, air temperature during air cooling is ambient air temperature. In some embodiments, the outer cover air cools for 2-3.5 seconds. In some embodiments, the outer cover cools for approximately 2.75 seconds. At 406, the outer cover is placed in water to cool further. In some embodiments, a temperature of the water is between 50° F. and 70° F. In some embodiments, a temperature of the water is approximately 64° F. In some embodiments, the outer cover air cools for 5-6 seconds. In some embodiments, the outer cover cools for approximately 5.55 seconds. This process slows the rate of cooling of outer covers, which causes it to be more flexible and less prone to shape memory effects when fully cooled.

While the above processes describe manufacturing a flexible outer cover 106 by a combination of air cooling and water cooling, it is contemplated that such a flexible outer cover may be manufactured with only air cooling or only water cooling. For instance, in some embodiments, the outer cover may be air cooled at two different temperatures and/or for two different lengths of time to achieve the desired flexibility. In some embodiments, the outer cover may be water cooled at two different temperatures and/or for two different lengths of time to achieve the desired flexibility.

At 408, once outer cover 106 is at least partially cooled, the intumescent strips 102 and 104 may be inlayed into the outer cover 106. In some embodiments, the intumescent strips 102 and 104 are inlayed into divots 116 in outer cover 106. At 410, adhesive backing may be applied to a back surface of the outer cover 106 and intumescent strips 102 and 104, forming gasket 100.

At 412, the gasket 100 may then be cut to any desired length. At 414, the gasket 100 may be rolled to form spool 300 for storage, shipping, and stocking. For example, as seen in FIG. 5, an approximately 18-foot-long gasket 100 is rolled to form spool 300, such that spool 300 may fit into a 9 inch-by-9 inch box 302. However, it is contemplated that any suitable length of gasket 100 may be rolled to form spool 300. In some embodiments, spool 300 includes a tube, such as a cardboard tube, configured to support spool 300 in a generally circular configuration. In some embodiments, spool 300 does not include a tube.

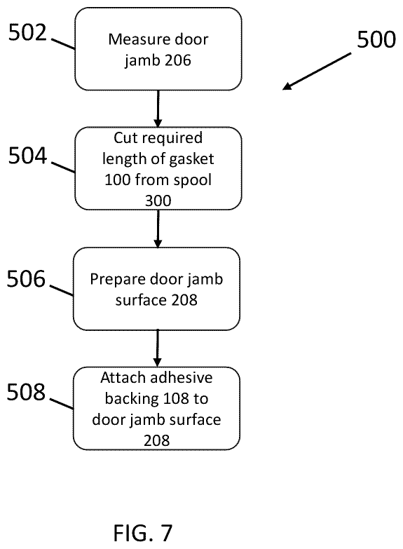

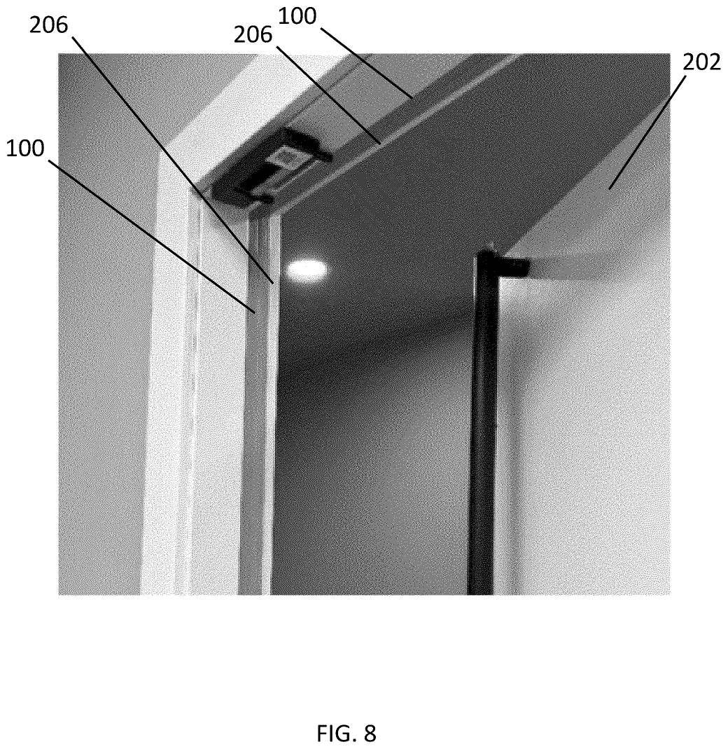

FIG. 7 shows a flowchart detailing a method of attaching gasket 100 from spool 300 to door jamb 206. FIG. 8 shows gaskets 100 attached to door jambs 206 using the method described in FIG. 7. At 502, the door jamb is first measured to determine the length of gasket 100 which is required. At 504, this required length is then cut from spool 300. At 506, the door jamb surface 508 is prepared by cleaning, sanding, or any other suitable method. At 508, the gasket 100 is attached to the door jamb 206 by applying the adhesive backing 108 to the door jamb surface 208. This process 500 is repeated for each door jamb which requires a gasket 100. In some embodiments, gasket 100 is cut into multiple strips. In some embodiments, gasket 100 may be applied to multiple door jambs, such as a latch side door jamb and header side door jamb as a single continuous strip. In some embodiments, gasket 100 may be applied to a single door jamb 206 as multiple strips spaced to avoid door hardware such as latches or hinges.

While the above embodiments describe gasket 100 applied to a door jamb to seal gaps between the door jamb and a side of the door, it is contemplated that gasket 100 may be applied in any configuration to seal any kind of gap. For instance, gasket 100 may be applied to door side 204 instead of being applied to door jamb surface 208. Gasket 100 may also be used on a meeting stile or astragal between two doors. Gasket 100 may also be applied to windows, or any other openings.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A fire-resisting gasket comprising:
an outer casing;
at least one intumescent strip at least partially surrounded by the outer casing, the at least one intumescent strip configured to expand when exposed to a temperature above a threshold temperature; and
an adhesive backing material attached to the outer casing to hold the intumescent material to the outer casing and configured to secure the fire-resisting gasket to a support surface;
wherein the fire-resisting gasket is flexible and rolled into a spool.

2. The fire-resisting gasket of claim 1, wherein the support surface is a side of a door jamb, and wherein as the at least one intumescent strip expands, the fire-resisting gasket expands to fill a gap between the side of the door jamb and a side of a door.

3. The fire-resisting gasket of claim 1, wherein the outer casing comprises a polyvinyl chloride (PVC) material.

4. The fire-resisting gasket of claim 1, wherein the outer casing is configured to soften when exposed to the temperature above the threshold temperature, such that the outer casing may stretch as the intumescent strip expands.

5. The fire-resisting gasket of claim 1, wherein the outer casing is formed by extrusion.

6. The fire-resisting gasket of claim 2, wherein the fire-resisting gasket is configured to prevent passage of fire between the door jamb and the side of the door facing the door jamb for at least 45 minutes when the intumescent strip is expanded.

7. The fire-resisting gasket of claim 1, wherein the at least one intumescent strip is a first intumescent strip, and further comprising a second intumescent strip substantially parallel to the first intumescent strip.

8. The fire-resisting gasket of claim 2, wherein the outer casing further comprises at least one fin configured to restrict a flow of smoke through the gap.

9. The fire-resisting gasket of claim 8, wherein the fin restricts the flow of smoke while the at least one intumescent strip is unexpanded.

10. The fire-resisting gasket of claim 8, wherein the at least one fin is a first fin, and further comprising second and third fins extend approximately parallel to the first fin.

11. The fire-resisting gasket of claim 8, wherein the at least one fin is a first fin, and further comprising second and third fins extend at opposing angles relative to the first fin.

12. The fire-resisting gasket of claim 1, wherein the fire-resisting gasket has a thickness of less than ⅛ inch when the at least one intumescent strip is unexpanded.

13. (canceled)

14. The fire-resisting gasket of claim 1, wherein the at least one intumescent strip is configured to expand to cause the gasket to seal a gap between the support surface and a corresponding surface to prevent fire from travelling through the gap, and wherein the gap is greater than ⅛ inch.

15. The fire-resisting gasket of claim 2, wherein the fire-resisting gasket is configured to prevent passage of fire through the gap for at least 45 minutes when the gap is greater than ⅛ inches when the intumescent strip is expanded.

16.-19. (canceled)

20. A method of forming a spool of fire-resisting gasket, the fire-resisting gasket comprising an outer casing, at least one intumescent strip at least partially surrounded by the outer casing, and an adhesive backing material attached to the outer casing, the method comprising:
extruding the outer casing at a pre-determined temperature;
cooling the outer casing such that the outer casing remains flexible;
inlaying the at least one intumescent strip into the outer casing;
attaching the adhesive backing to the outer casing;
cutting the fire-resisting gasket to a pre-determined length; and
rolling the fire-resisting gasket into a spool.

21. The method of claim 20, wherein the pre-determined temperature is between 300° F. and 350° F.

22. (canceled)

23. The method of claim 20, wherein cooling the outer casing comprises air cooling the outer casing for a first period of time.

24.-26. (canceled)

27. The method of claim 23, wherein cooling the outer casing further comprises water cooling the outer casing for a second period of time after air cooling the outer casing for the first period of time.

28.-31. (canceled)

32. A method of installing a section of fire-resisting gasket onto a support surface from a spool of fire-resisting gasket, the fire-resisting gasket comprising an outer casing, at least one intumescent strip at least partially surrounded by the outer casing, and an adhesive backing material attached to the outer casing, the method comprising:
measuring a length of the support surface;
unrolling at least a portion of the fire-resisting gasket from the spool of the fire-resisting gasket;
cutting off a section of the fire-resisting gasket from the unrolled fire-resisting gasket, the section having a cut length corresponding to the length of the support surface; and
attaching the adhesive backing to the support surface along the length of the support surface.

33.-36. (canceled)

37. The method of claim 32, wherein the support surface is a surface of a door jamb.
